(19) United States
(12) Patent Application Publication
(10) Pub. No.: US 2017/0313516 A1
(43) Pub. Date: Nov. 2, 2017

(54) Order Management Apparatus and Order Management Method

(71) Applicant: Hitachi, Ltd., Chiyoda ku,Tokyo (JP)

(72) Inventors: Yoriko KAZAMA, Tokyo (JP); Junichi KIMURA, Tokyo (JP)

(21) Appl. No.: 15/528,852

(22) PCT Filed: Mar. 18, 2015
(86) PCT No.: PCT/JP2015/058024

§ 371 Date: May 23, 2017

(51) Int. Cl. B65G 1/137

(52) U.S. Cl. CPC B65G 1/137

(57) ABSTRACT

An order management apparatus holds storage rack information in which identification information of articles and identification information of storage racks holding the articles are registered, identifies identification information of storage racks holding articles identified by identification information of articles included in the received orders with reference to the storage rack information, creates order groups from the received orders to satisfy a condition that orders for which identification information on the same storage rack is identified belong to the same order group, so as to transport the storage racks in a minimum number of trips to the workstation, notifies the worker in the workstation of orders belonging to one of the created order groups, and sends a transport instruction to the transport vehicle to transport a storage rack holding an article in at least one order belonging to the order group the worker in the workstation is notified of.

### BACKGROUND

This invention relates to an order management apparatus for managing orders each including an article to be delivered and a delivery destination of the article.

There exists picking work for the workers in a warehouse or a factory to pick an article from a rack in accordance with an order. There is a way to retrieve an ordered article that the worker walks around the warehouse equipped with racks holding articles and retrieve the ordered article. JP 2011-037568 A (Patent Literature 1) discloses a technique for this way of picking: The article picking system is provided for determining a travel passage and a travel distance of each folded type container in the storage installation, determining, when there are a specified number of folded type containers having the same travel passage, a set of the folded type containers as one pickup unit, selecting the folded type container having the longest travel distance out of the remaining folded type containers, combining the folded type container having the longest travel distance with the other folded type containers and calculating the travel distance of the combination, and determining the set of combined folded type containers having the least elongated travel distance, as the other pickup unit (Abstract).

Meanwhile, there is another way that, instead of the worker walking down to the rack to retrieve an article, a transport vehicle brings the rack to the worker so that the worker can retrieve an article from the delivered rack. WO 2007/011814 A (Patent Literature 2) discloses a technique for this way of picking: A method for retrieving inventory items within an inventory system includes receiving a retrieval request that identifies an inventory item and selecting, from a plurality of inventory stations, an inventory station to fulfill an order associated with the retrieval request. The method also includes selecting an inventory holder from a plurality of inventory holders that store the inventory item and selecting, from a plurality of mobile drive units, a mobile drive unit: to move the selected inventory holder to the selected inventory station (Abstract).

Patent Literature 1: JP 2011-037568 A

Patent Literature 2: WO 2007/011814 A

### SUMMARY

The technique according to JP 2011-037568 A creates a combination of orders that attains the shortest walking distance for the worker but targets a system where the worker moves to access a plurality of racks. This technique cannot be applied to a system where a transport vehicle delivers a rack to the worker because the transport vehicle cannot transport a plurality of racks at one time.

The technique according to WO 2007/011814 A does not take account of a combination of orders in instructing a transport vehicle to transport a rack corresponding to an order; accordingly, it does not matter whether the worker can simultaneously work on multiple orders with the rack delivered to the worker.

The technique according to WO 2007/011814 A may issue an instruction to the transport vehicle in order of reception of the orders; one trip of a transport vehicle allows a worker to process one order and in addition, an order previous to or following the order fortunately including the same kind of article, if such an order exists. Accordingly, the technique according to WO 2007/011814 A cannot process multiple orders efficiently.

All the orders can be sorted so that the same article will be included consecutively; however, in a case where one order includes a plurality of kinds of articles (for example, A, B, C, and D), if the orders are sorted by the article A, the article A can be retrieved with one trip. However, the other articles B, C, and D in this order cannot be retrieved until the other racks are delivered in other trips; the work on this order is not completed unless the articles B, C, and D are retrieved, which can impair the working efficiency.

This invention is accomplished to provide an order management system that improves the working efficiency by reducing the number of transport trips of a transport vehicle in a system where a transport vehicle delivers a rack to the worker.

A representative example of the invention is an order management apparatus configured to manage orders each including an article to be delivered and a delivery destination of the article, each order being processed by transporting, by a transport vehicle, a storage rack holding the article to be delivered to a workstation and allocating, by a worker, the article held in the storage rack for the delivery destination, the order management apparatus being configured to: hold storage rack information in which identification information of articles and identification information of storage racks holding the articles are registered; receive input of the orders; identify identification information of storage racks holding articles identified by identification information of articles included in the received orders with reference to the storage rack information; create order groups from the received orders to satisfy a condition that orders for which identification information on the same storage rack is identified belong to the same order group, so as to transport the storage racks in a minimum number of trips to the workstation; notify the worker in the workstation of orders belonging to one of the created order groups; and send a transport instruction to the transport vehicle to transport a storage rack holding an article in at least one order belonging to the order group the worker in the workstation is notified of.

A representative aspect of the invention in this disclosure attains advantageous effects as follows. Briefly, in a system where a transport vehicle delivers a rack to the worker, an order management system is provided that improves the working efficiency by reducing the number of transport trips of a transport vehicle.

The issues, configurations, and effects other than those described above are clarified in the following description of embodiments.

### BRIEF DESCRIPTION OF THE DRAWINGS

FIG. 1 is an explanatory diagram of an order picking system in Embodiment 1;

FIG. 2 is a functional block diagram of the order picking system in Embodiment 1;

FIG. 3 is a diagram of a hardware configuration of a controller in Embodiment 1;

FIG. 4A is an explanatory diagram of order data in Embodiment 1;

FIG. 4B is an explanatory diagram of the order data in Embodiment 1 after rack IDs are added;

FIG. 4C an explanatory diagram of the order data in Embodiment 1 after group IDs and transport IDs are added;

FIG. 5 is a sequence diagram of the processing in the order picking system in Embodiment 1;

FIG. 6A is an explanatory diagram of order data in Embodiment 2;

FIG. 6B is an explanatory diagram of the order data in Embodiment 2 after shelf IDs are added;

FIG. 6C an explanatory diagram of the order data in Embodiment 2 after group IDs and transport IDs are added;

FIG. 7 is an explanatory diagram of order data after workstations and vehicles are added;

FIG. 8 is an explanatory diagram of an order picking system in Embodiment 4;

FIG. 9 is a functional block diagram of the order picking system in Embodiment 4;

FIG. 10 is a sequence diagram of the processing in an order picking system in Embodiment 5;

FIG. 11 is a functional block diagram of an order picking system in Embodiment 6;

FIG. 12A is an explanatory diagram of storage rack data in Embodiment 6;

FIG. 12B is an explanatory diagram of the storage rack data in Embodiment 6 after workstations are added;

FIG. 13A is an explanatory diagram of order data in Embodiment 6 after shelf IDs and group IDs are added;

FIG. 13B is an explanatory diagram of the order data in Embodiment 6 after shelf IDs, group IDs, transport IDs, and workstations are added; and

FIG. 14 is a sequence diagram of processing of the order picking system in Embodiment 6.

### DETAILED DESCRIPTION OF THE EMBODIMENTS

### Embodiment 1

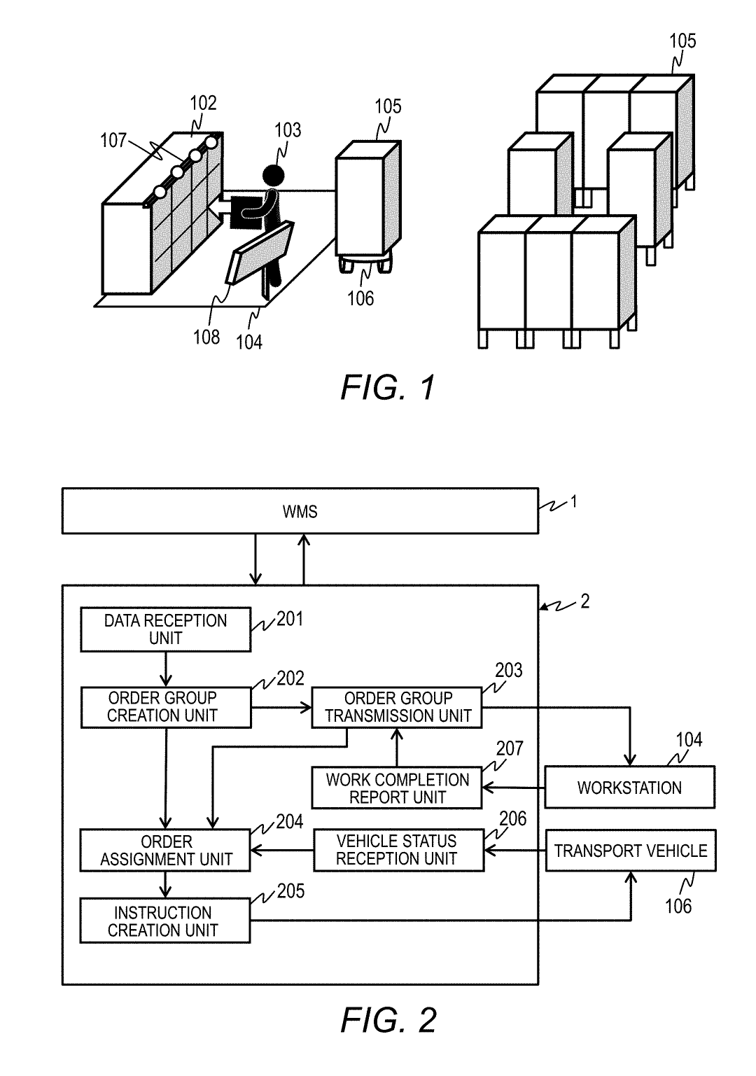

Embodiment 1 is described with reference to FIGS. 1 to 5.

FIG. 1 is an explanatory diagram of an order picking system in Embodiment 1.

This embodiment describes work to allocate ordered articles for delivery destinations in a warehouse or a factory where multiple articles are stored, by way of example.

FIG. 1 is an explanatory diagram of an outline of picking work in an order picking system in Embodiment 1.

A warehouse is provided with a plurality of storage racks 105 holding articles. A transport vehicle 106 transports a designated storage rack 105 to a workstation 104 in accordance with an instruction from a controller (order management apparatus) 2 shown in FIG. 2. The worker 103 retrieves an ordered article from the storage rack 105 transported by the transport vehicle 106 and puts the retrieved article in a compartment of a sorting rack 102 placed in the working station 104. The sorting rack 102 has a plurality of compartments; each compartment is associated with a delivery destination. A plurality of compartments may be associated with one delivery destination. As a result, an article included in an order is allocated for the delivery destination of the article.

The workstation 104 is equipped with work instruction lamps 107 or a work instruction terminal 108. The work instruction lamps 107 are provided correspondingly to the compartments. The work instruction lamp 107 of the compartment where to put the article retrieved from the storage rack 105 transported by the transport vehicle 106 lights up to inform the worker 103 of the compartment where to put the article.

The work instruction terminal 108 can be a computer including an output device such as a display. The work instruction terminal 108 displays a list of orders to be processed at the workstation 104. The worker 103 can check the delivery destination of an article retrieved from the storage rack 105 transported by the transport vehicle 106 and further, the compartment where to put the article corresponding to the delivery destination by consulting the work instruction terminal 108.

It is sufficient if the workstation 104 be equipped with either the work instruction lamps 107 or the work instruction terminal 108; the work instruction lamps 107 and the work instruction terminal 108 are generally referred to as work instruction device.

The shape of the storage rack 105 is not limited to the shape of rack; the articles may be held on pallets. The shape of the sorting rack 102 is not limited to the shape of rack; a plurality of boxes held on a movable cart can be used as compartments.

FIG. 2 is a functional block diagram of the order picking system in Embodiment 1.

The order picking system includes a warehouse management system (WMS) 1, a controller 2, a workstation 104, and a transport vehicle 106.

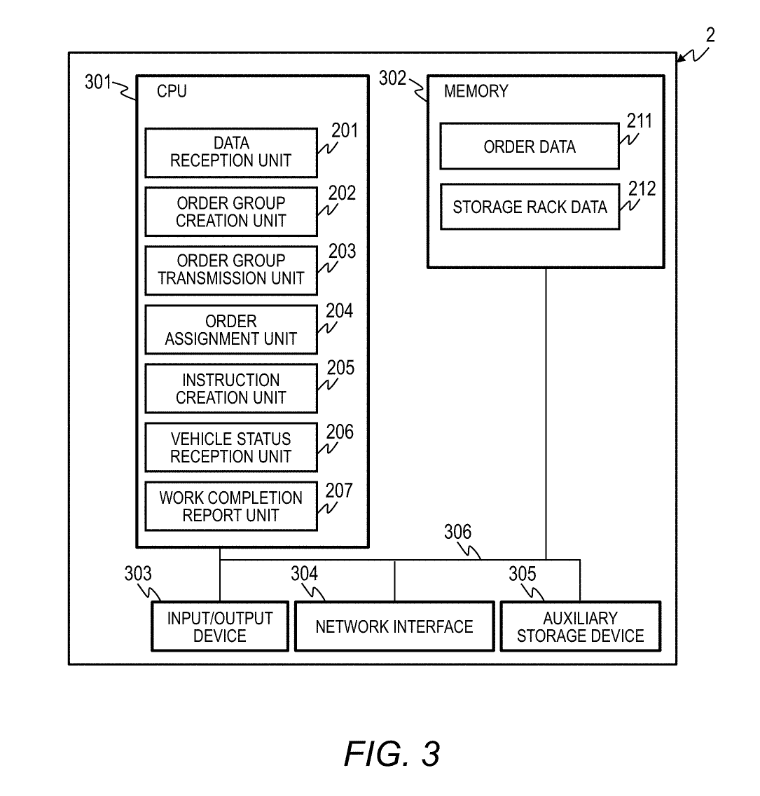

The WMS 1 manages data on the articles in a warehouse or a factory and data on work. The data on the articles includes storage rack data 212 (see FIG. 3), for example. The storage rack data 212 includes identification information of each article and identification information of the storage rack 105 holding the article. The data on work includes orders, for example. Each order includes a relationship of a delivery destination and identification information of the articles to be delivered to the destination.

The controller 2 manages the orders to be processed at the workstation 104 and sends an instruction to transport a storage rack 105 to the transport vehicle 106.

The controller 2 includes a data reception unit 201, an order group creation unit 202, order group transmission unit 203, an order assignment unit 204, an instruction creation unit 205, a vehicle status reception unit 206, and a work completion report unit 207.

The data reception unit 201 receives orders and storage rack data 212 from the WMS 1, registers the received orders to order data 211 in the memory 302 shown in FIG. 3, and stores the received storage rack data 212 to the memory 302.

The order group creation unit 202 creates order groups based on the plurality of orders registered in the order data 211 so that the number of trips of the transport vehicle 106 will be the minimum. That is to say, the order group creation unit 202 creates order groups in such a manner that orders for an article held in the same storage rack 105 will belong to the same order group. In this connection, the maximum number of delivery destinations of the orders belonging to one order group should be the number of compartments of the sorting rack 102.

The order group transmission unit 203 sends an order group created by the order group creation unit 202 to the work instruction device installed in the workstation 104. The timing for the order group transmission unit 203 to send an order group is when the order group transmission unit 203 receives a request for an order group from the work instruction device or when all the work on the previous order group sent to the work instruction device is completed. Since an order group is sent when all the work on the previous order group sent to the work instruction device is completed, the order group can reserve the compartments of the sorting rack 102 to put the articles retrieved from the storage racks 105 transported by the transport vehicle 106 to the workstation 104.

The order assignment unit 204 selects an order on which a transport instruction has not been sent from the order group already sent to the workstation 104 and assigns the order to the transport vehicle 106 that has finished transporting a storage rack 105. If a plurality of transport vehicles 106 that have finished transporting a storage rack 105 exist, the order assignment unit 204 assigns the order to the transport vehicle 106 that can reach the storage rack 105 holding the ordered article with the shortest travel.

The instruction creation unit 205 calculates a route for the transport vehicle 106 assigned an order by the order assignment unit 204 to reach the storage rack 105 holding the ordered article and further, to travel from the storage rack 105 to the workstation 104 and sends a transport instruction including the calculated route to the transport vehicle 106. It is desirable that the route to the storage rack 105 and further to the workstation 104 be the shortest one.

Upon receipt of the transport instruction sent from the instruction creation unit 205, the transport vehicle 106 moves along the route included in the received transport instruction and transports the storage rack 105. The transport vehicle 106 sends status report information including its own location and the status of work to the controller 2. Examples of the statuses of work include a status of moving toward a storage rack 105, a status of transporting a storage rack 105 to the workstation 104, a status of returning a storage rack 105, and a status of having completed transport work.

The vehicle status reception unit 206 notifies the order assignment unit 204 that a transport vehicle 106 has completed transport work if the status report information received from transport vehicles 106 includes status report information indicating the status of having completed transport work.

The work instruction device installed in the workstation 104 instructs the worker 103 to do picking work based on the information on the order group received from the order group transmission unit 203 when a transport vehicle 106 carrying the storage rack 105 arrives at the workstation 104. For example, in the case where the work instruction device is work instruction lamps 107, the lamps corresponding to the compartments where to put the article in the storage rack 105 that has arrived at the workstation 104 are turned on. In this case, the controller 2 creates information that associates the individual delivery destinations of the order group with compartments and when the status report information received from the transport vehicle 106 indicates the status of arrival at the workstation 104, sends instructions to light to the work instruction lamps 107 of the compartments corresponding to the delivery destinations of the article to be retrieved from the storage rack 105 transported by the transport vehicle 106.

In the case where the work instruction device is the work instruction terminal 108, the orders associated with the storage rack 105 that arrives at the workstation 104 may be highlighted on the display showing the orders belonging to the order group. In this case, when the status report information received from the transport vehicle 106 indicates the status of arrival at the workstation 104, the controller 2 sends an instruction to highlight the orders for the article to be retrieved from the storage rack 105 transported by the transport vehicle 106 to the work instruction terminal 108.

After the worker 103 puts the article retrieved from the storage rack 105 in the corresponding compartments, the work instruction device receives an input indicating that the orders for the article have been processed and sends a completion report to the controller 2.

Upon receipt of the completion report from the work instruction device, the work completion report unit 207 determines whether the work has been completed on all orders included in the order group sent to the workstation 104 where the work instruction device is installed. If determining that the work on all orders has been completed, the work completion report unit 207 notifies the order group transmission unit 203 of the completion of the work.

As described above, the controller 2 creates order groups that attain the minimum number of trips of the transport vehicle 106 from a plurality of orders and sends the order groups to the work instruction device installed in the workstation 104; accordingly, the worker 103 can be informed of the article to be retrieved at once from the storage rack 105 transported by the transport vehicle 106 that arrives at the workstation 104. Hence, even if order groups that attains the minimum number of trips of the transport vehicle 106 are created, high working efficiency is achieved.

FIG. 3 is a diagram of a hardware configuration of the controller 2 in Embodiment 1.

The controller 2 is a common computer and includes a CPU 301, a memory 302, an input/output device 303, a network interface 304, and an auxiliary storage device 305. The CPU 301, the memory 302, the input/output device 303, the network interface 304, and the auxiliary storage device 305 are connected with one another through a bus 306.

The CPU 301 performs various arithmetic operations. The auxiliary storage device 305 is a non-volatile and non-transitory storage medium and stores various programs and data. The memory 302 is a volatile and transitory storage medium. The various programs and data stored in the auxiliary storage device 305 are loaded to the memory 302 and the CPU 301 executes the programs loaded on the memory 302 to read and write data loaded on the memory 302.

The CPU 301 includes the data reception unit 201, the order group creation unit 202, the order group transmission unit 203, the order assignment unit 204, the instruction creation unit 205, the vehicle status reception unit 206, and the work completion report unit 207. The memory 302 stores the programs corresponding to the data reception unit 201, the order group creation unit 202, the order group transmission unit 203, the order assignment unit 204, the instruction creation unit 205, the vehicle status reception unit 206, and the work completion report unit 207, and further, order data 211 and storage rack data 212. The CPU 301 executes these programs stored in the memory 302 to implement the functions of the data reception unit 201, the order group creation unit 202, the order group transmission unit 203, the order assignment unit 204, the instruction creation unit 205, the vehicle status reception unit 206, and the work completion report unit 207.

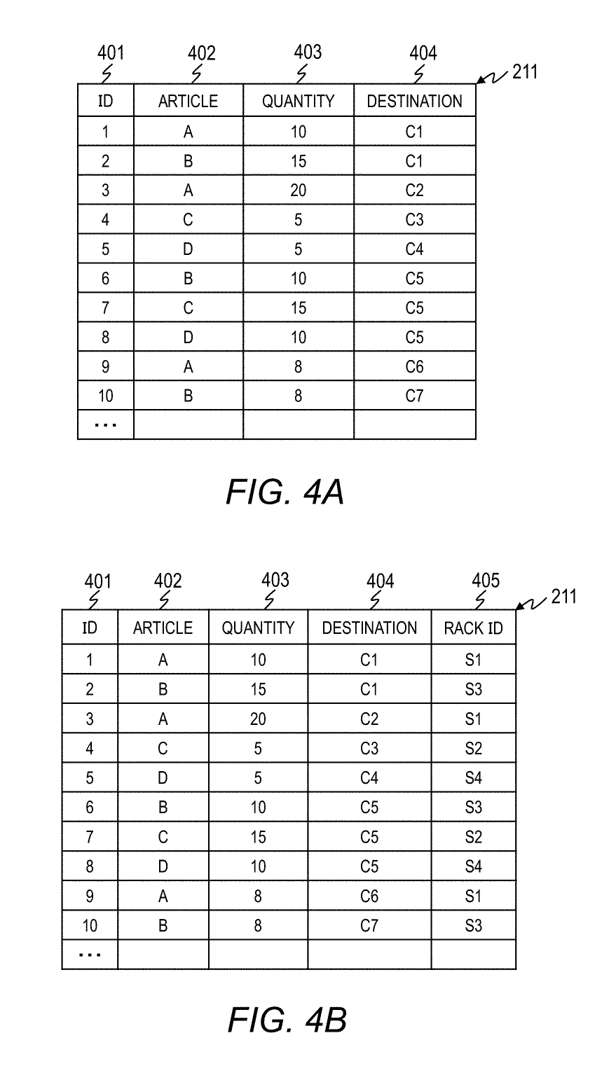

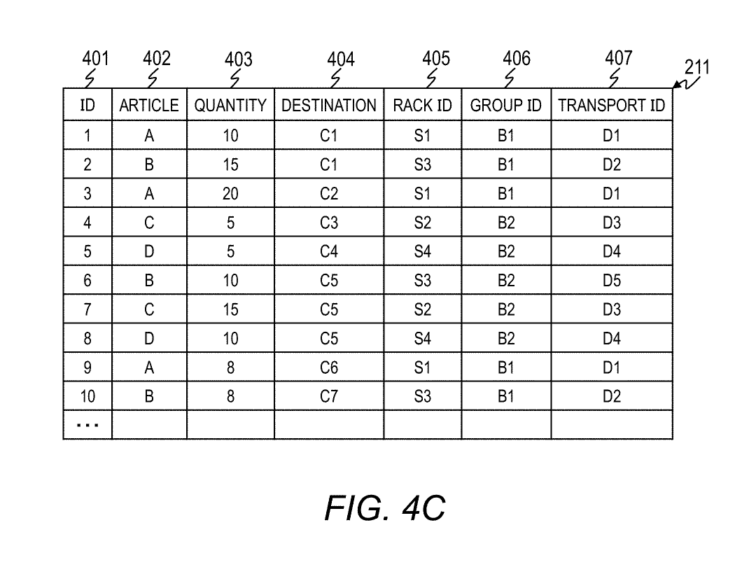

The order data 211 stored in the memory 302 is to register identification information of each article to be delivered, the quantity of the article to be delivered, and the delivery destination. The details of the order data 211 will be described with FIG. 4A.

The storage rack data 212 stored in the memory 302 is to register identification information of each storage rack 105, identification information of the article stored in the storage rack 105, and the quantity of the article stored in the storage rack 105.

The network interface 304 includes an interface for communicating data with the WMS 1, an interface for communicating data with the workstation 104, and an interface for communicating data with the transport vehicle 106. The controller 2, the WMS 1, and the work instruction device can be connected by wire or wireless, although the controller 2 and the transport vehicle 106 are connected by wireless.

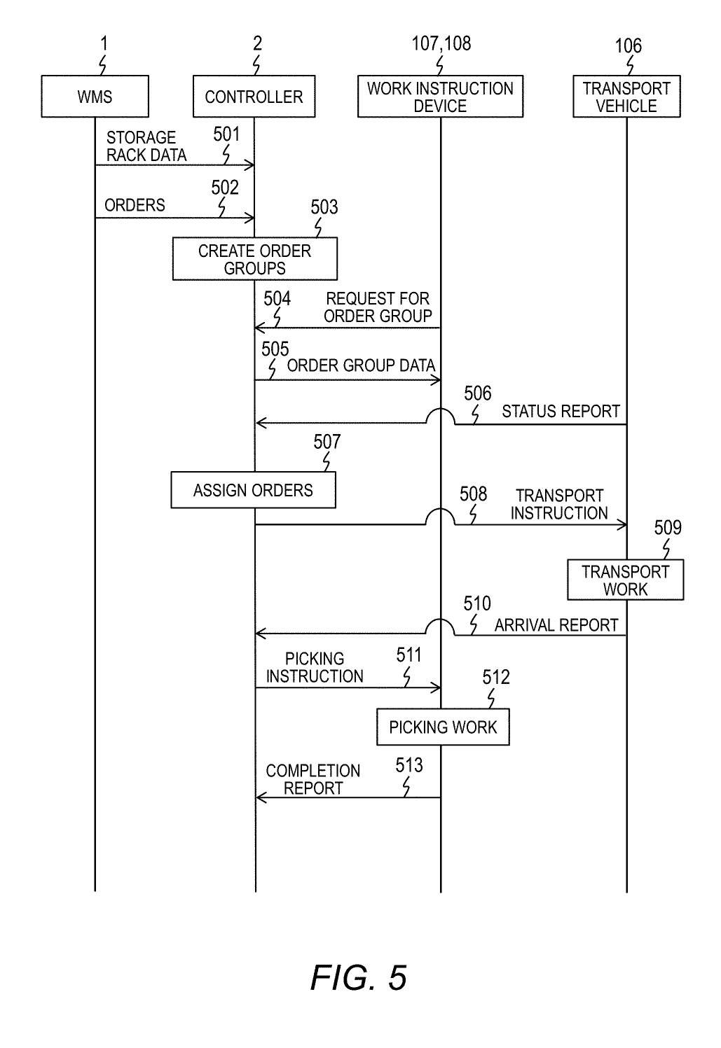

Next, processing of the order group creation unit 202 to create order groups is described using FIGS. 4A to 4C and FIG. 5.

FIG. 4A is an explanatory diagram of order data 211 in Embodiment 1.

The order data 211 includes IDs 401, articles 402, quantities 403, and destinations 404. In each ID 401, identification information of the row (order line) of the order data 211 is registered. In each article 402, identification information of the article to be delivered is registered. The identification information of the article is to identify the kind of the article. In each quantity 403, the quantity of the article to be delivered is registered. In each destination 404, the delivery destination of the article is registered.

In this regard, an order is received at the data reception unit 201 from the WMS 1 in the form where identification information of at least one article to be delivered to a destination and the quantities of the articles are associated with the delivery destination; however, each order line of the order data 211 is provided for one article; accordingly, one order can be registered into multiple order lines. For example, an order to a delivery destination C1 is registered in two order lines of ID1 and ID2 shown in FIG. 4A.

First, the order group creation unit 202 adds, to each order line of the order data 211, identification information of the storage rack 105 holding the article of the order line as a rack ID 405 with reference to the storage rack data 212. FIG. 4B is an explanatory diagram of the order data 211 in Embodiment 1 after the rack IDs 405 are added.

Next, the order group creation unit 202 creates order groups with reference to the rack IDs 405 and adds identification information of each order group as a group ID 406 to each order line belonging to the same group. FIG. 4C is an explanatory diagram of the order data 211 in Embodiment 1 after group IDs 406 and transport IDs 407 are added.

The order group creation unit 202 adds the identification information of the same group to the order lines including the same identification information in the rack ID 405. That is to say, the order group creation unit 202 puts the orders including an article held in the same storage rack 105 into one group. This is because the worker 103 can do the picking work on the article for the order lines including the identification information of the same storage rack 105 in the rack ID 405 at once when the storage rack 105 arrives at the workstation 104. For example, the order lines of ID1 and ID3 in FIG. 4C include the same value “S1” in the rack ID 405; accordingly, the same “B1” is registered in the group IDs 406 of the order lines of ID1 and ID3.

The order group creation unit 202 also adds the identification information of the same group to the order lines including the same delivery destination in the destination 404. That is to say, the order group creation unit 202 eliminates order lines for the same delivery destination from belonging to different order groups. The destinations 404 of the order lines of ID1 and ID2 in FIG. 4C include the same value “C1”; accordingly, the same “B1” is registered in the group IDs 406 of these order lines of ID1 and ID2.

The reason why the order lines for the same delivery destination should belong to the same order group is to complete the picking work of all the articles included in each order with the compartments of the sorting rack 102. This policy eliminates the work of combining the articles for the same delivery destination subsequent to the picking work, achieving high working efficiency.

In accordance with the above-described policy, the order line of ID2 is determined to belong to the order group including the order lines of ID1 and ID3 because the delivery destination of the order line of ID2 is the same as the delivery destination of the order line of ID1. Since the number of delivery destinations that can be included in one order group is the number of compartments of the sorting rack 102 at maximum, the order group creation unit 202 adds a group ID to order lines in a number not more than this value.

Taking an example where the sorting rack 102 has four compartments, the order lines of ID1 to ID3, ID9, and ID10 in FIG. 4C belong to the group having a group ID B1 and are to be delivered to four delivery destinations of C1, C2, C6, and C7. The order line of ID6 includes a rack ID S3, which is the same as the rack IDs of the order lines of ID2 and ID10; however, the order line of ID6 does not belong to the order group having the group ID B1 because the number of delivery destinations of the group having the group ID B1 exceeds four.

The order group creation unit 202 adds the same transport identification information as a transport ID 407 to each order line where the same identification information is registered in the rack ID 405 out of the order lines belonging to a created order group.

The above-described arrangement can complete the picking work on all orders consisting of ten order lines shown in FIGS. 4A to 4C with five trips (D1 to D5) of the transport vehicle 106 to transport a storage rack 105. If the transport vehicle 106 transports a storage rack 105 for each separate order line, ten trips to transport a storage rack 105 are required for all the order lines. Accordingly, this embodiment can reduce the number of trips of the transport vehicle 106.

The reason why the order line of ID6 should not belong to the order group B1 is described. Assuming that the order lines of ID1 to ID3 are included in the order group B1, there is no order line including the delivery destination of either C1 or C2 other than the order lines of ID1 to ID3 and therefore, the order group B1 should include order lines having a rack ID of S1 or S3. In FIG. 4C, the order line of ID9 includes the rack ID S1 is and the order lines of ID6 and ID10 include the rack ID S3.

The delivery destination of the order line of ID6 is C5. Except for the order line of ID6, the order lines of ID7 and ID8 include the delivery destination C5. Since the order lines including the same destination have to belong to the same order group, if the order line of ID6 is included in the order group B1, the order lines of ID7 and ID8 have to be included in the order group B1.

For example, in a case where the order lines of ID1 to ID3 and ID6 are put in an order group B1 and the order lines of ID4, ID5, and ID10 are put in an order group B2, the order group B1 requires four trips because of four rack IDs of S1 to S4 and the order group B2 requires three trips because of three rack IDs of S2 to S4. Accordingly, the ten order lines require seven trips. The smallest number of trips is achieved when the order lines of ID1 to ID3, ID9, and ID10 belong to the order group B1 and the order lines of ID4 to ID8 belong to the order group B2; accordingly, the order line of ID6 should not belong to the order group B1 but belong to the order group B2.

The order group transmission unit 203 sends an order group created by the order group creation unit 202 to the work instruction device installed in the workstation 104. The order lines belonging to the order group sent by the order group transmission unit 203 are treated as the order lines ready to be assigned to the transport vehicle 106; the order assignment unit 204 assigns only the order lines ready to be assigned to the transport vehicle 106 and does not assign the order lines not ready to be assigned to the transport vehicle 106. As a result, compartments can be reserved without a miss for the article to be retrieved from the storage rack 105 transported by the transport vehicle 106 when the transport vehicle 106 arrives at the workstation 104.

The order assignment unit 204 assigns, upon receipt of a report that the transport vehicle 106 has completed transport work from the vehicle status reception unit 206, a batch of order lines to the transport vehicle 106. The batch of order lines to be assigned to the transport vehicle 106 includes one or more order lines belonging to the order group sent to the work instruction device and not sent to the transport vehicle 106 in an instruction. The order assignment unit 204 treats the order lines assigned the same transport identification information as a batch.

The instruction creation unit 205 retrieves the identification information of the storage rack 105 from the order line(s) assigned to the transport vehicle 106 and calculates the shortest route from the current location of the transport vehicle 106 to the storage rack 105 identified by the retrieved identification information. The instruction creation unit 205 also calculates the shortest route from the storage rack 105 identified by the retrieved identification information to the workstation 104. The instruction creation unit 205 sends a transport instruction including the destination of the transport vehicle 106 and the shortest route to the transport vehicle 106.

Alternatively, it can be configured so that the instruction creation unit 205 notifies the transport vehicle 106 of the storage rack 105 and the workstation 104 to be the destinations and the transport vehicle 106 calculates the routes to the destinations.

The transport vehicle 106 moves along the route included in the transport instruction from the instruction creation unit 205 to transport the storage rack 105. The transport vehicle 106 sends status report information including its own location and the status of work to the controller 2. The location of the transport vehicle 106 should be a point on a predefined map and represented by coordinates (X, Y), for example. The examples of the status of work include a status of moving toward a storage rack 105, a status of transporting a storage rack 105 to a workstation 104, a status of returning a storage rack 105, and a status of having completed transport work.

If the status report information from the transport vehicle 106 indicates the status of having completed transport work, the transport vehicle 106 that has sent the status report information can be assigned the next batch of order lines; accordingly, the vehicle status reception unit 206 that has received such status report information notifies the order assignment unit 204 of the information on the transport vehicle 106.

The work instruction device installed in the workstation 104 that has received the order group sent by the order group transmission unit 203 notifies the worker 103, upon arrival of the transport vehicle 106 carrying a storage rack 105, of the article to be retrieved from the storage rack 105 and the compartments where to put the article. The worker 103 performs picking work based on the information received from the work instruction device and, upon completion of the picking work, inputs completion of the work to the work instruction device. Upon receipt of the input indicating the completion of the picking work, the work instruction device sends a completion report to the controller 2.

Upon receipt of the completion report from the work instruction device, the work completion report unit 207 determines whether the work on all orders belonging to the order group sent to the workstation equipped with the work instruction device has been completed. If determining that the work on all orders has been completed, the work completion report unit 207 notifies the order group transmission unit 203 of the completion of the work.

FIG. 5 is a sequence diagram of the processing in the order picking system in Embodiment 1.

The data reception unit 201 of the controller 2 receives storage rack data 212 from the WMS 1 (501) and stores the received storage rack data 212 to the memory 302. The data reception unit 201 also receives orders from the WMS 1 and registers the received orders to the order data 211 in the memory 302. The WMS 1 can collectively send a predetermined number of orders to the controller 2 or alternatively, forward one by one to the controller 2 each time of receipt of an order.

For example, when a predetermined number or more of newly registered orders are included in the order data 211, the order group creation unit 202 creates order groups (503).

When the controller 2 receives a request for an order group from the work instruction device (504), the order group transmission unit 203 sends one of the order groups created at Step 503 to the work instruction device (505). In this example, it is assumed that the order group transmission unit 203 sends a group of order lines in FIG. 4C including a group ID of B1. The work instruction device sends a request for an order group in starting work, for example.

Next, the controller 2 receives status report information from the transport vehicle 106 (506) and if the received status report information indicates the status of having completed transport work, the order assignment unit 204 assigns order lines having the same transport ID to the transport vehicle 106 that has completed transport work; the instruction creation unit 205 sends the transport vehicle 106 a transport instruction to transport the storage rack 105 on the order lines to the workstation 104 (507). In this example, the instruction creation unit 205 may send a transport instruction to transport the storage rack 105 on the order lines of ID1, ID2, and ID3 showing a transport ID of D1 in FIG. 4C.

The transport vehicle 106 performs transport work based on the transport instruction from the controller 2 (509).

Upon arrival at the workstation 104, the transport vehicle 106 sends status report information indicating the status of arrival at the workstation 104 to the controller 2 (510). Upon receipt of the status report information, the controller 2 sends the work instruction device an instruction (picking instruction) to notify the worker 103 of the article to be retrieved from the storage rack 105 transported by the transport vehicle 106 and the compartments where to put the article. Upon receipt of the picking instruction, the work instruction device notifies the worker 103 of the article to be retrieved from the storage rack 105 and the compartments where to put the article; the worker 103 performs picking work based on the information in the instruction (512). When the worker 103 has completed the picking work, the worker 103 inputs the completion of work to the work instruction device; the work instruction device sends a completion report to the controller 2 (513).

In summary, the controller 2 (order management apparatus) in this embodiment creates order groups so that orders including identification information of the same storage rack 105 will belong to the same order group to achieve the minimum number of trips, notifies the worker 103 in the workstation 104 of the orders included in one of the created order groups, and sends the transport vehicle 106 a transport instruction to transport the storage rack 105 storing an article included in an order belonging to the order group the worker 103 is notified of. This configuration achieves the minimum number of trips of the transport vehicle 106 and further, enables the worker 103 to be informed of the article to be retrieved from the storage rack transported by the transport vehicle each time the transport vehicle 106 arrives at the workstation 104; accordingly, high working efficiency is achieved.

Furthermore, the controller 2 in this embodiment creates an order group so that the orders for the same delivery destination will belong to the same order group and the number of delivery destinations of the orders belonging to the order group will be equal to or smaller than the number of compartments. This configuration enables all articles to be delivered in each order to be allocated within an order group and eliminates the work of combining the articles allocated to be delivered for one order; accordingly, higher working efficiency is achieved.

Meanwhile, the controller 2 notifies the worker 103 in the workstation 104 of the orders belonging to another order group after completion of the work in the workstation 104 of allocating the articles included in all orders belonging to an order group for the delivery destinations; accordingly, the new order group can be sent to the workstation 104 where all the compartments are ready to be used. Furthermore, the controller 2 sends a new transport instruction to a transport vehicle that has finished transporting a storage rack; accordingly, a smaller number of standing-by transport vehicles or high working efficiency can be achieved.

### Embodiment 2

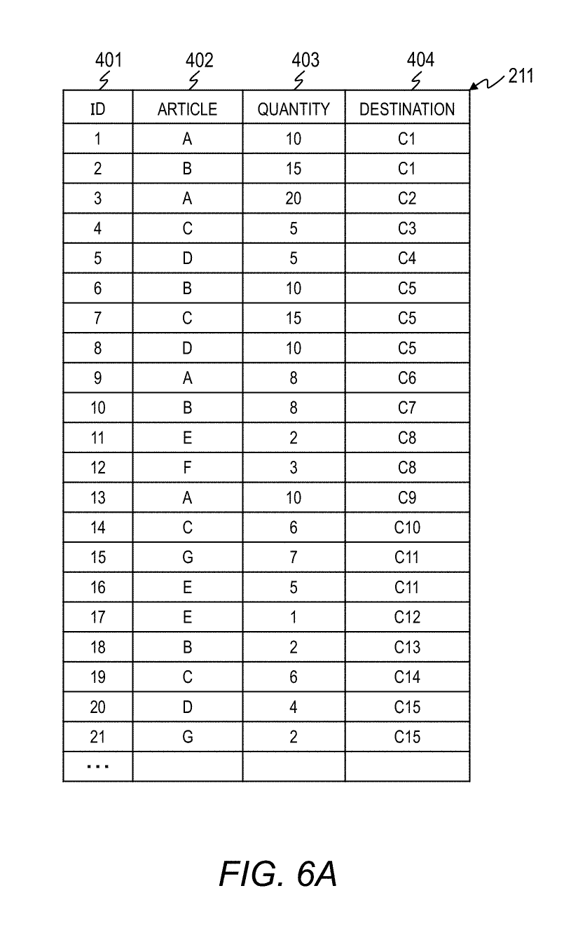

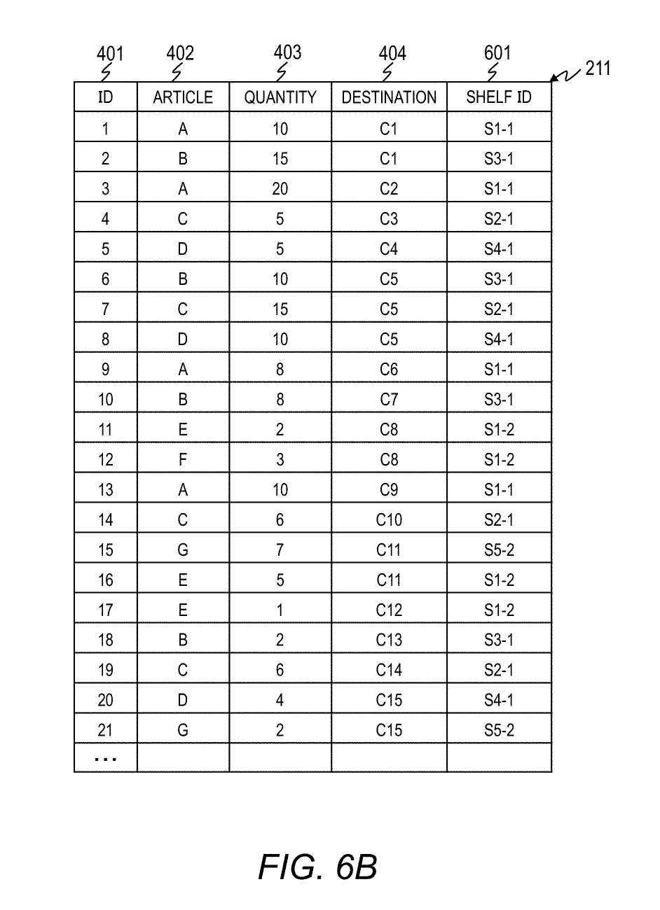

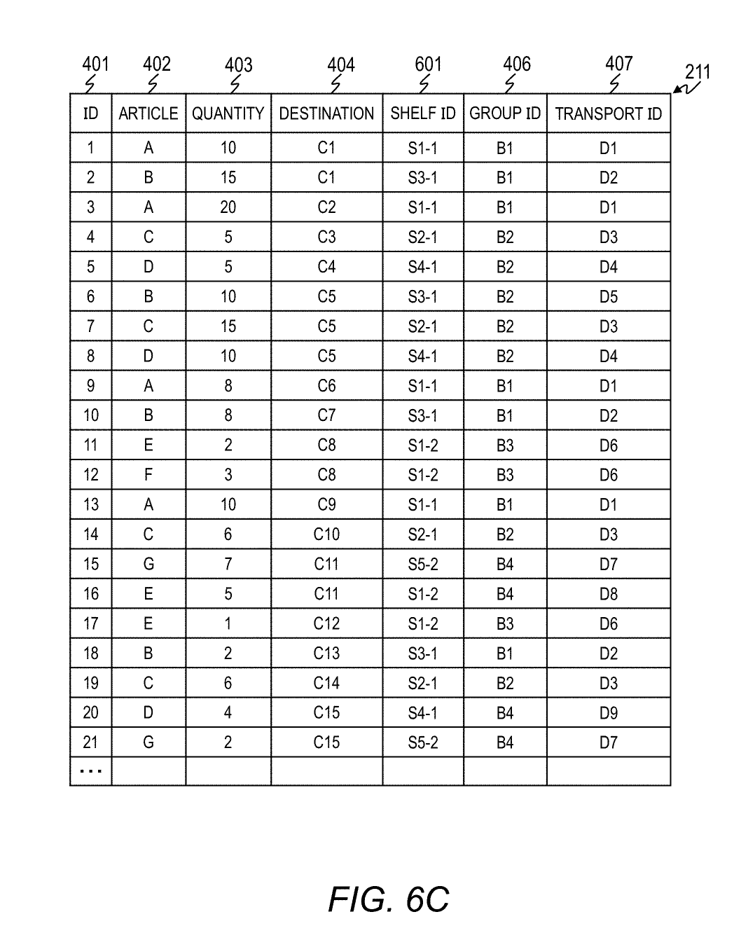

Embodiment 2 is described with reference to FIGS. 6A to 6C.

This embodiment describes a case where the storage racks 105 have a plurality of shelves for storing articles and the order group creation unit 202 creates order groups while taking account of the shelves. This embodiment describes the differences from Embodiment 1 and omits the explanation of the same parts as Embodiment 1.

This embodiment is described based on an assumption that the worker 103 can retrieve an article from only one shelf of the storage rack 105 transported by the transport vehicle 106; however, the worker 103 can be allowed to retrieve articles from a plurality of shelves.

In the storage rack data 212 in this embodiment, identification information of each article is associated with identification information of a shelf of a storage rack 105. The identification information of a shelf is information that can also identify a storage rack 105. For example, if given identification information of a shelf is “S1-1”, “S1” represents the identification information of the storage rack 105 and “1” represents identification information of the shelf. Accordingly, the identification information of a shelf can identify a storage rack 105 and a shelf of the storage rack 105 holding an article. However, the identification information of a shelf can be information that identifies a shelf only. In this case, identification information of an article associated with identification information of a storage rack 105 holding the article and identification information of a shelf holding the article is registered in the storage rack data 212.

FIG. 6A is an explanatory diagram of order data 211 in Embodiment 2. The order data 211 is different from the order data 211 shown in FIG. 4A in the point that the order data 211 includes order lines of ID1 to ID21. The order lines of ID1 to ID10 in FIG. 6A are identical to the order lines of ID1 to ID10 in FIG. 4A.

The order group creation unit 202 adds identification information of a shelf as a shelf ID 601 to each order received from the WMS 1 and registered in the order data 211. FIG. 6B is an explanatory diagram of the order data 211 in Embodiment 2 after shelf IDs 601 are added.

Next, the order group creation unit 202 creates order groups from the plurality of order lines registered in the order data 211 and including the shelf IDs 601 so that order lines for the same delivery destination will be in the same order group and the number of trips of the transport vehicle 106 based on the identification information of the storage racks will be the minimum, and adds a group ID 406 and a transport ID 407 to each order line. In this operation, the order group creation unit 202 creates order groups that attain the minimum number of trips for the transport vehicle 106 to satisfy the condition that order lines including the same storage rack but different shelves will not belong to the same order group, with reference to the identification information of the shelves registered in the shelf IDs 601. Since the time to change shelves of a storage rack 105 transported by the transport vehicle 106 to the workstation 104 is not counted as the standby time for the worker 103, this policy achieves high working efficiency for the worker 103. Accordingly, this policy is effective in the cases where it takes a long time to change shelves to pick an article within a storage rack 105 transported by the transport vehicle 106 to the workstation 104 and where the system has a good enough number of transport vehicles 106 and the storage racks 105 can arrive at the workstation 104 in a short time.

FIG. 6C is an explanatory diagram of the order data 211 in Embodiment 2 after group IDs 406 and transport IDs 407 are added.

In FIG. 6C, the order lines for articles stored in the storage rack S1 are the order lines of ID1, ID3, ID9, ID11 to ID13, ID16, and ID17. Among these order lines, the order lines of ID1, ID3, ID9, and ID13 include the same shelf identification information “S1-1” and accordingly, they belong to the same order group B1. However, the order lines of ID11, ID12, ID16, and ID17 including different shelf identification information “S1-2” belong to an order group different from the order group B1.

For example, in the case where an order group B1 is sent to the work instruction device in the workstation 104 and the transport vehicle 106 transports the storage rack 105 of S1 to the workstation 104, the worker 103 retrieves the article A from the shelf S1-1 for the order lines of ID1, ID3, ID9, and ID13 including a value S1-1 in the shelf IDs 601 and allocates the article A to the compartments corresponding to the delivery destinations C1, C2, C6, and C9 to complete the picking work on these order lines.

In this embodiment, the order group creation unit 202 can create order groups that attain the minimum number of trips of the transport vehicle 106 to satisfy the condition that order lines of the same storage rack but different shelves are included in the same order group, with reference to the identification information of the shelves registered in the shelf IDs 601. Since the time for the transport vehicle 106 to transport a storage rack 105 is not counted as the standby time of the worker 103, this policy achieves high working efficiency for the worker 103. Accordingly, this policy is effective in the cases where the shelves to pick an article can be changed in a short time within a storage rack 105 transported by the transport vehicle 106 to the workstation 104 and where it takes a long time to bring a storage rack 105 to the workstation 104. The reasons for taking a long time to bring a storage rack 105 to the workstation 104 can include that there are only a small number of transport vehicles 106, that the warehouse has a large area, and that the speed of the transport vehicle 106 is slow.

Whether to put order lines including different shelves on the same storage rack in the same order group can be determined appropriately depending on the number of transport vehicles 106, the performance of the transport vehicles 106, the area of the warehouse, and other factors. As a result, order groups that provide high working efficiency for the worker 103 can be created.

### Embodiment 3

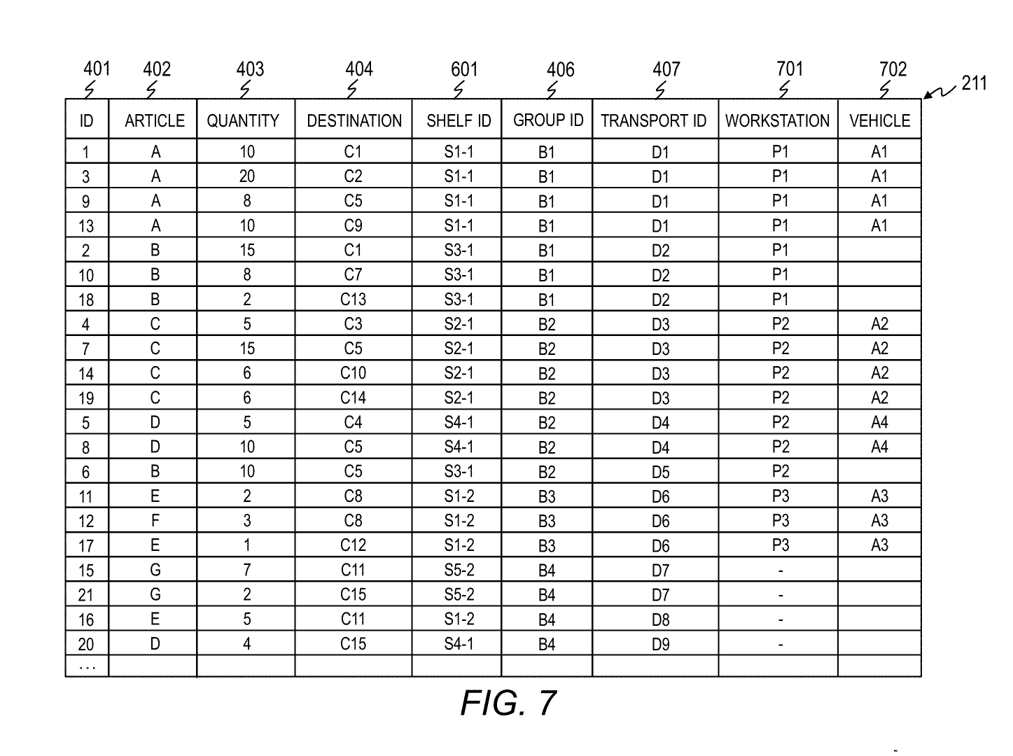

Embodiment 3 is described with reference to FIG. 7.

This embodiment describes an example of a case where the system includes a plurality of workstations 104. FIG. 7 is an explanatory diagram of the order data 211 after workstations 701 and vehicles 702 are added. The order data shown in FIG. 7 additionally includes workstations 701 and vehicles 702.

Each workstation 701 is to register identification information of the workstation 104 equipped with the work instruction device to which an order group has been sent. Each vehicle 702 is to register identification information of the assigned transport vehicle 106 to which a transport instruction has been sent. These columns are for the controller 2 to manage the workstations 104 equipped with the work instruction devices to which order groups have been sent and the transport vehicles 106 to which transport instructions have been sent.

The order group transmission unit 203 sends order groups in the order of receiving a request for an order group from the work instruction devices installed in the workstations 104. The order group transmission unit 203 stores the identification information of the workstation 104 equipped with the work instruction device to which the order group transmission unit 203 has sent an order group to the workstations 701 of the order lines belonging to the order group.

The order assignment unit 204 assigns order lines to a transport vehicle 106 that has sent status report information indicating completion of transport work. The order assignment unit 204 stores the identification information of the transport vehicle 106 to the vehicles 702 of the order lines that have been assigned to the transport vehicle 106.

FIG. 7 is obtained by sorting the order data 211 shown in FIG. 6 by the group ID 406 and the transport ID 407 and adding the columns of workstations 701 and vehicles 702. According to FIG. 7, the order groups B1, B2, and B3 have been sent to the work instruction devices installed in the workstations P1, P2, and P3, respectively. Furthermore, the order lines provided with the transport IDs D1, D3, D4, and D6 have been assigned to the transport vehicles A1, A2, A4, and A3, respectively, and the order lines provided with the transport IDs D2 and D5 have not been assigned to a transport vehicle 106.

Upon receipt of status report information indicating completion of transport work from a transport vehicle 106 through the vehicle status reception unit 206, the order assignment unit 204 assigns the order lines provided with the transport ID of D2 or D5 to the transport vehicle 106 that has sent the status report information indicating completion of transport work.

The above-described configuration enables assigning the order lines depending on the status of each transport vehicle 106 even in the case a plurality of workstations 104 exist.

The order assignment unit 204 can calculate the numbers of transport vehicles 106 to which transport instructions have been sent separately by workstation 104 with reference to the order data 211 shown in FIG. 7 and determine the order lines to be assigned to the transport vehicle 106 that has sent status report information indicating completion of transport work based on the numbers of transport vehicles 106.

For example, according to FIG. 7, each of the workstations P1 and P3 has been assigned one transport vehicle 106 and the workstation P2 has been assigned two transport vehicles 106.

The order assignment unit 204 then assigns order lines belonging to the order group sent to the workstation 104 to which the fewest transport vehicles 106 have been assigned to the transport vehicle 106 that has sent the status report information indicating completion of transport work. In this example, order lines belonging to the order group B1 sent to the workstation P1 and provided with a transport ID of D2 are newly assigned to the transport vehicle 106. This policy can equalize the number of transport vehicles 106 assigned to each workstation 104, reduce the congestion of transport vehicles 106, and further, reduce the waiting time of each transport vehicle 106 at a workstation 104.

The order lines to be newly assigned to a transport vehicle 106 that has sent status report information indicating completion of transport work can be determined based on another value, instead of the numbers of transport vehicles 106 assigned to the workstations 104. This arrangement can level the progress of the work among a plurality of workstations 104,

This embodiment has been described based on Embodiment 2 in which shelves are taken into account, but is applicable to Embodiment 1 in which the shelves are not taken into account.

### Embodiment 4

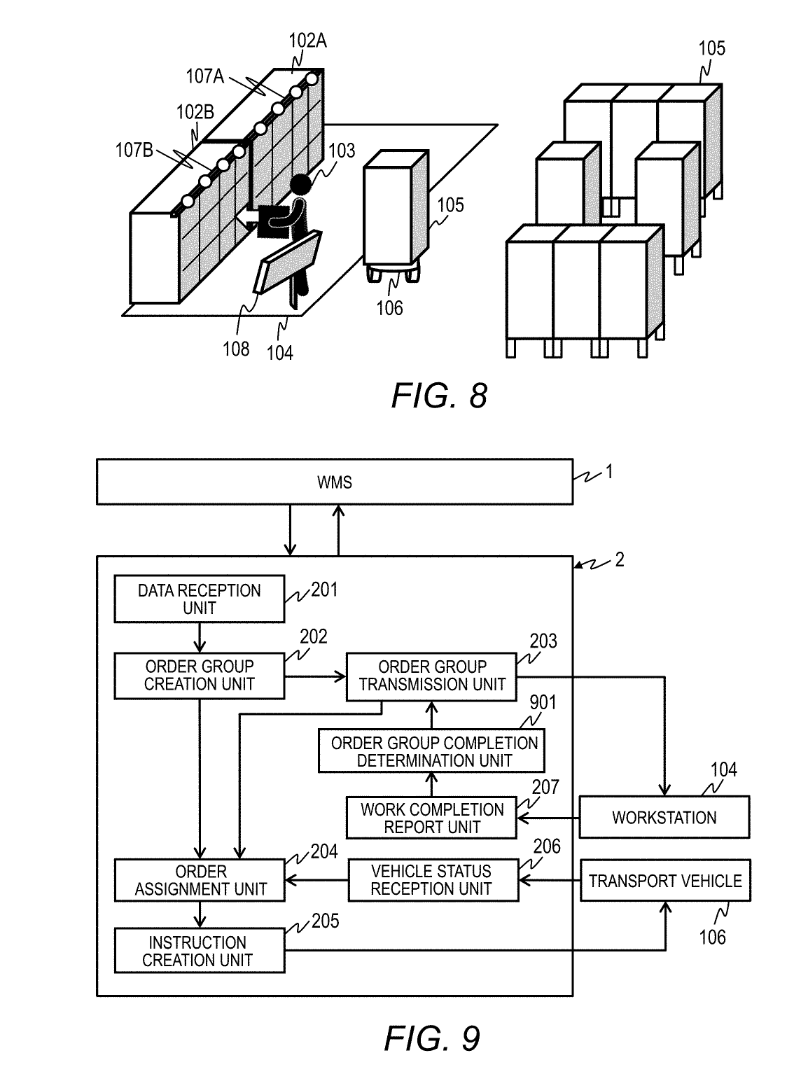

Embodiment 4 is described with reference to FIGS. 8 and 9.

This embodiment describes an example where the compartments of the workstation 104 are grouped by a specific number.

FIG. 8 is an explanatory diagram of an order picking system in Embodiment 4.

In FIG. 8, two sorting racks 102A and 102B are provided in a single workstation 104. The workstation 104 is equipped with work instruction lamps 107A for the sorting rack 102A and work instruction lamps 107B for the sorting rack 102B.

The worker 103 retrieves a specified article from the storage rack 105 transported by a transport vehicle 106 to the workstation 104 and puts the article in the specified compartments of at least either the sorting rack 102A or 102B. In FIG. 8, the compartments in the workstation 104 are grouped into the compartments of the sorting rack 102A and the compartments of the sorting rack 102B.

FIG. 9 is a block diagram of the order picking system in Embodiment 4.

The order group transmission unit 203 in this embodiment sends as many order groups as the compartment groups in one workstation 104 to the workstation 104. Described with FIG. 8 is an example where the compartments are grouped by sorting rack 102, but the policy of grouping is not limited to this. If one sorting rack 102 has 20 compartments, the compartments can be grouped by 10 compartments and each group may be regarded as a virtual sorting rack. The number of groups in one workstation 104 is not limited to two. It should be noted that the number of delivery destinations of the orders belonging to one order group created by the order group creation unit 202 is to be the number of compartments in the group at maximum.

The controller 2 in this embodiment includes an order group completion determination unit 901 in addition to the configuration shown in FIG. 2.

Upon receipt of a completion report from a work instruction device, the work completion report unit 207 outputs the received completion report to the order group completion determination unit 901.

Upon receipt of the completion report from the work completion report unit 207, the order group completion determination unit 901 identifies, with reference to the completion report, the order group including the orders on which the work has been completed in the order groups sent to the work instruction devices in the workstation 104. The order group completion determination unit 901 determines whether the work on all the orders belonging to the identified order group has been completed.

If the work on all the orders of the order group has been completed, the order group completion determination unit 901 outputs a request for an order group to the order group transmission unit 203. Upon receipt of the request for an order group from the order group completion determination unit 901, the order group transmission unit 203 sends an order group to the work instruction device installed in the workstation 104.

In this embodiment, a workstation 104 is assigned as many order groups as the compartment groups in the workstation 104; when the work on all orders belonging to an order group is completed, the order group transmission unit 203 sends a new order group to the workstation 104.

Since the workstation 104 has a plurality of compartment groups and as many order groups as the compartment groups are assigned to the workstation 104; the worker 103 can perform picking work on the orders belonging to another order group even in a case where transporting the storage rack 105 for the last order in one order group is taking time. Accordingly, higher working efficiency is achieved.

In this embodiment, the compartments in a workstation 104 are divided into a plurality of groups and each group is assigned an order group. When the work on all the orders in an order group assigned to a group is completed, the group is assigned the next order group. For this reason, compared to the case of assigning a single order group to all the compartments in the workstation 104, this embodiment can assign order groups one after another and reduce the number of transport vehicles 106 standing by after having completed transport work.

As described above, the order group transmission unit 203 sends an order group after completion of the work on all the orders in the previous order group sent to a work instruction device in a workstation 104. In this operation, the order group transmission unit 203 can select an order group including an order line including the identification information of an article or a shelf same as an unprocessed order line in another order group sent to another work instruction device in the workstation 104 as the next order group and send the selected order group to the work instruction device in the workstation 104.

This policy increases the possibility that the order lines belonging to the order group newly assigned to the workstation 104 be for the same article or an article that can be retrieved from the same shelf as an order line of the already assigned order group. Then, the article of the newly assigned order group and the article of the already assigned order group can be retrieved together from the storage rack 105 upon arrival at the workstation 104, so that the transport vehicle 106 can reduce the number of transport trips and achieve higher working efficiency.

It should be noted that this embodiment is applicable to Embodiments 1 to 3.

### Embodiment 5

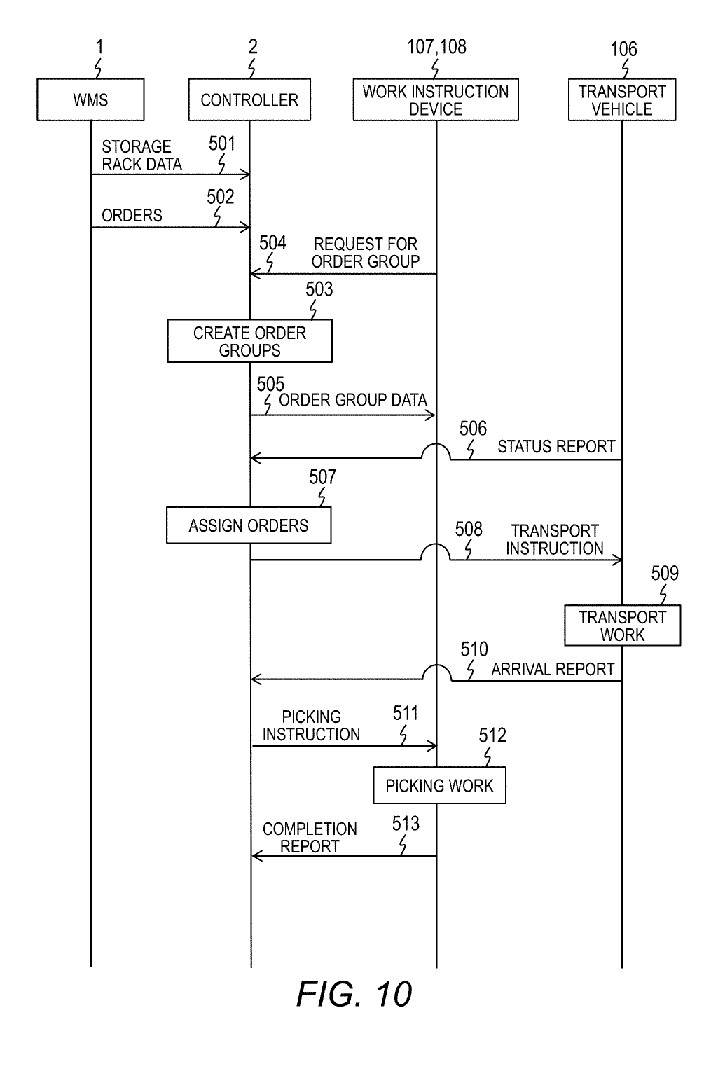

Embodiment 5 is described with reference to FIG. 10.

In Embodiments 1 to 4, the controller 2 creates order groups in advance and sends one of the order groups to a work instruction device in a workstation 104 in response to receipt of a request for an order group from the work instruction device. In this embodiment, the controller 2 creates an order group in response to receipt of a request for an order group from a work instruction device in a workstation 104 and sends the created order group to the work instruction device.

FIG. 10 is a sequence diagram of processing of the order picking system in Embodiment 5. FIG. 10 is different from FIG. 5 only in the points that the work instruction device sends a request for an order group at Step 504 and that the controller 2 creates an order group at Step 503 in response to receipt of the request for an order group. Since the remaining is the same as FIG. 5, the description thereof is omitted.

At Step 503, the orders that can be used to create an order group are the orders not yet sent to the work instruction device in the workstation 104 and the ordered articles are stored in storage racks 105. The order group creation unit 202 of the controller 2 may create one order group or a plurality of order groups.

When being applied to a case where work to store articles to storage racks 105 is performed concurrently with picking work, this embodiment creates an order group based on the articles stored in storage racks 105 at the time of receipt of a request for an order group, which can prevent a trouble in picking work such that the storage rack 105 that arrives at the workstation 104 does not hold the ordered article.

This embodiment has been described based on Embodiment 2 in which shelves are taken into account but is applicable to Embodiment 1 in which the shelves are not taken into account and also, applicable to Embodiments 3 and 4.

### Embodiment 6

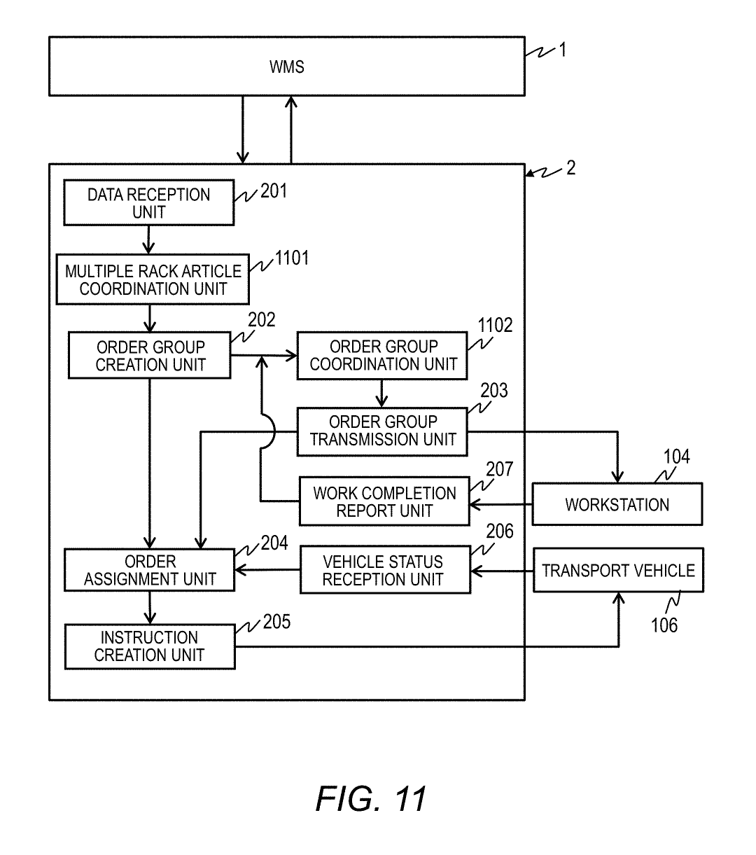

Embodiment 6 is described with reference to FIGS. 11 to 14.

This embodiment describes creating order groups in the case where one kind of article is stored in a plurality of storage racks 105.

FIG. 11 is a functional block diagram of the order picking system in Embodiment 6.

The controller 2 in this embodiment includes multiple rack article coordination unit 1101 and an order group coordination unit 1102 in addition to the configuration shown in FIG. 2.

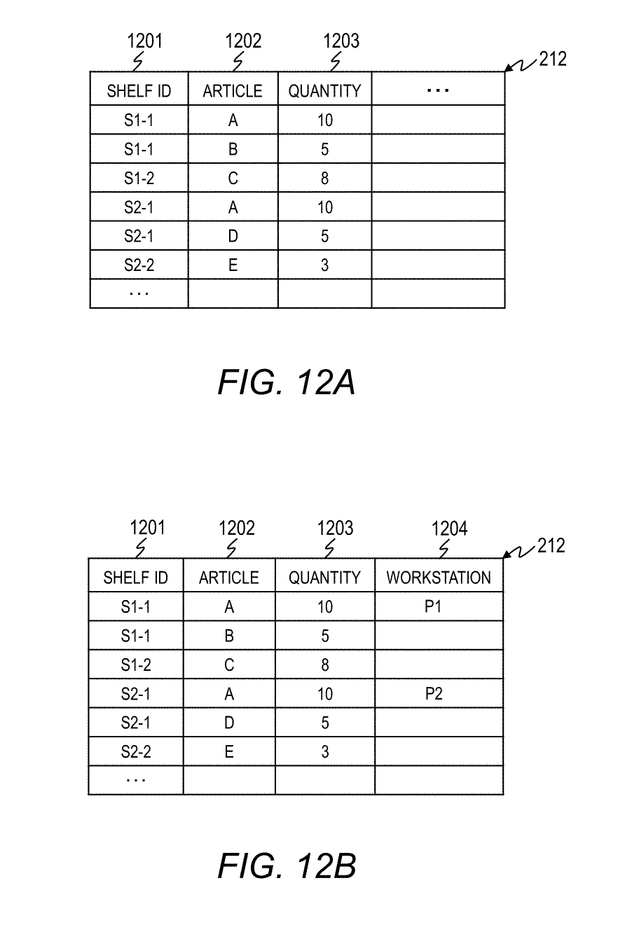

The multiple rack article coordination unit 1101 extracts records indicating that a kind of article is stored in multiple storage racks 105 from the storage rack data 212 received at the data reception unit 201 and registers the identification information of the workstation 104 closest from the storage rack 105 to each of the extracted records. The multiple rack article coordination unit 1101 will be described in detail with FIGS. 12A and 12B.

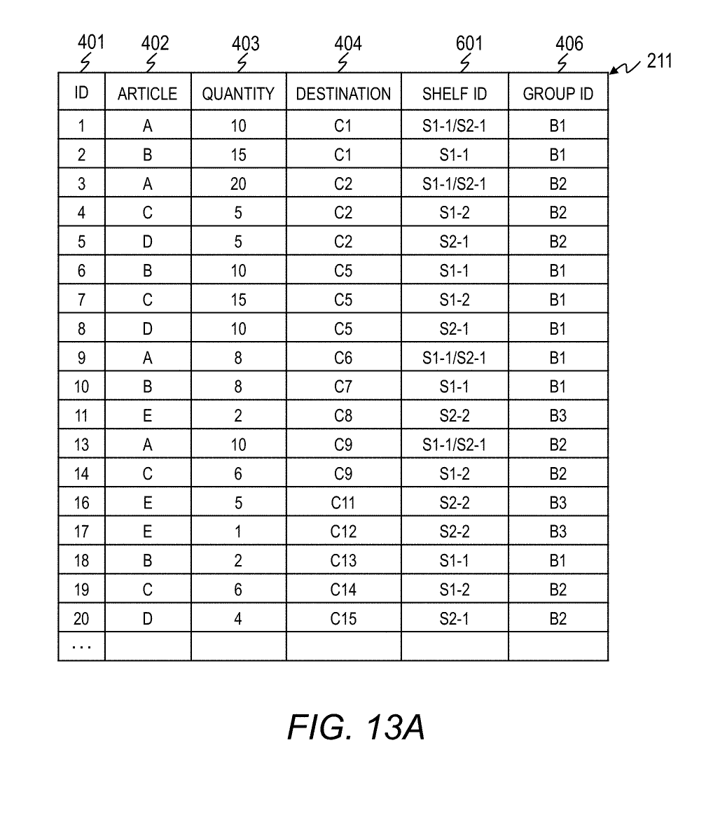

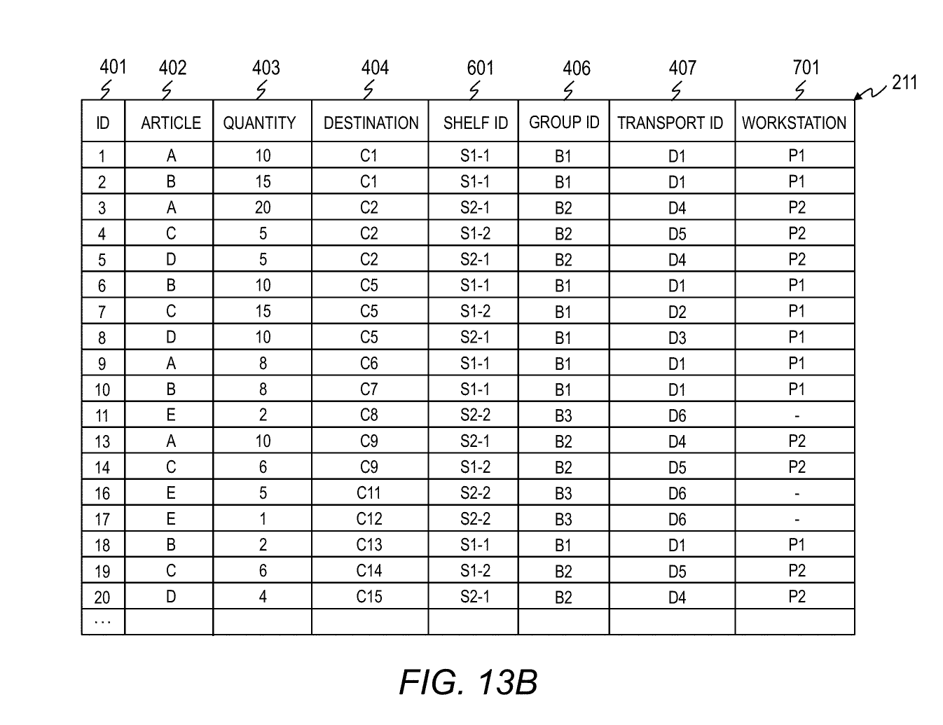

The order group coordination unit 1102 determines identification information of the shelf where to retrieve the article on an order line belonging to an order group created by the order group creation unit 202, if identification information of a plurality of shelves are registered in the shelf ID 601 of the order line. The order group coordination unit 1102 determines the identification information of the shelf to achieve the minimum number of trips of the transport vehicle 106, based on the other order lines in the same order group. The order group coordination unit 1102 will be described in detail with FIGS. 13A and 13B.

FIG. 12A is an explanatory diagram of storage rack data 212 in Embodiment 6.

The storage rack data 212 includes a shelf ID 1201, an article 1202, and a quantity 1203 in each record. The shelf ID 1201 is to register identification information of a shelf storing an article. The article 1202 is to register identification information of the article stored on the shelf identified by the identification information registered in the shelf ID 1201. The quantity 1203 is to register the quantity of the article stored on the shelf of the storage rack 105 identified by the identification information registered in the shelf ID 1201.

According to FIG. 12A, the article A is stored on the shelves S1-1 and S2-1; the multiple rack article coordination unit 1101 selects the records of shelf IDs S1-1 and S2-1. The multiple rack article coordination unit 1101 adds the identification information of the workstation closest from the storage rack 105 to the workstation 1204 in each record.

FIG. 12B is an explanatory diagram of storage rack data 212 in Embodiment 6 after workstations 1204 are added.

The closest to the storage rack S1 identified by the shelf ID S1-1 is the workstation P1 and the closest to the storage rack S2 identified by the shelf ID S2-1 is the workstation P2. Accordingly, the multiple rack article coordination unit 1101 registers a value P1 to the workstation 1204 of the record of the shelf ID S1-1 and a value P2 to the workstation 1204 of the record of the shelf ID S2-1.

This configuration eliminates the processing of determining a workstation 104 for each order line including an article stored in multiple storage racks 105; the processing load to the controller 2 can be lowered. Furthermore, since the workstation 104 closest to the storage rack 105 is selected, the transport vehicle 106 attains a shorter transport trip. However, the policy to determine the workstation where to perform picking work of an article stored in a plurality of storage racks 105 is not limited to this.

Regarding the articles not stored in a plurality of storage racks 105 (for example, the articles B and C), picking work can be performed at any workstation 104.

Next, the order group coordination unit 1102 is described with reference to FIGS. 13A and 13B.

FIG. 13A is an explanatory diagram of order data 211 in Embodiment 6 after shelf IDs 601 and group IDs 406 are added. FIG. 13B is an explanatory diagram of the order data 211 in Embodiment 6 after shelf IDs 601, group IDs 406, transport IDs 407, and workstations 701 are added.

In this embodiment, the order group creation unit 202 adds only the group IDs 406 to the order data 211 (which means the order group creation unit 202 creates order groups) but does not assign transport IDs 407. The order group creation unit 202 creates each order group in such a manner that an order line for an article including identification information of a plurality of shelves in the shelf ID 601 will belong to the same order group as the order lines for the same delivery destination as the order line. That is to say, the order group creation unit 202 determines to which order group an order line for an article stored in a plurality of storage racks 105 should belong, based on only the delivery destination. Order data 211 after the order group creation unit 202 has added group IDs 406 is FIG. 13A.

The order group coordination unit 1102 determines identification information of a single shelf for each order line including identification information of a plurality of shelves in the shelf ID 601 in the order data 211 in FIG. 13A and determines a transport ID 407 and a workstation 701 to assign the order line.

More specifically, if an order group including an order line having identification information of a plurality of shelves in the shelf ID 601 includes another order line for the same delivery destination and further, if the identification information of a shelf registered in the shelf ID 601 of the other order line for the same delivery destination matches the identification information of one of the shelves, the order group coordination unit 1102 registers the identification information of the shelf stored in the shelf ID 601 of the other order line for the same delivery destination to the shelf ID 601 of the order line having identification information of a plurality of shelves in the shelf ID 601.

If the order group including an order line having identification information of a plurality of shelves in the shelf ID 601 includes no other order line for the same delivery destination or if the order group includes another order line for the same delivery destination but the identification information of a shelf registered in the shelf ID 601 of the other order line for the same delivery destination does not match any of the identification information of the shelves, the order group coordination unit 1102 selects the order lines belonging to the same order group as the order line having the identification information of a plurality of shelves in the shelf ID 601 and counts the number of order lines having identification information of one of the plurality of shelves, shelf by shelf. The order group coordination unit 1102 registers the identification information of the shelf assigned the largest number of order lines in the shelf ID 601 of the order line having the identification information of a plurality of shelves in the shelf ID 601.

In FIG. 13A, the order lines for the article A (ID1, ID3, ID9, and ID13) have values of S1-1 and S1-2 in the shelf IDs 601.

The order line of ID2 for the same delivery destination as the order line of ID1 has a value S1-1 in the shelf ID 601, which matches the value S1-1 registered in the shelf ID 601 of the order line of ID1; accordingly, the order group coordination unit 1102 registers S1-1 to the shelf ID 601 of the order line of ID1.

Regarding the order line of ID9 belonging to the same order group B1 as the order line of ID1, there is no other order line for the same delivery destination as the order line of ID9. The order group B1 after S1-1 is registered in the shelf ID 601 of the order line of ID1 includes four order lines having S1-1 in the shelf IDs 601 and no order line having S2-1 in the shelf ID 601; accordingly, the order group coordination unit 1102 registers S1-1 to the shelf ID 601 of the order line of ID9. The order group coordination unit 1102 may count the number of order lines having S1-1 in the shelf ID 601 and the number of order lines having S2-1 in the shelf ID 601 among the order lines excluding the order line of ID1 from the order group B1.

With reference to the storage rack data 212 shown in FIG. 12B in which the record for the article A having a value S1-1 in the shelf ID has a value P1 in the workstation 1204, the order group coordination unit 1102 determines the workstation 104 to assign the order group B1 to be P 1. The order group coordination unit 1102 further registers P1 to the workstations 701 of all the order lines belonging to the order group B1.

The order lines of ID3 and ID13 having values of S1-1 and S2-1 in the shelf ID 601 belong to the order group B2. Since the order line of ID5 for the same delivery destination as the order line of ID3 has a value S2-1 in the shelf ID 601, the order group coordination unit 1102 registers S2-1 to the shelf ID 601 of the order line of ID3. Meanwhile, the order line of ID14 for the same delivery destination as the order line of ID13 has neither S1-1 nor S2-1 and the order group B2 includes two order lines having S2-1 in the shelf ID 601 and no order line having S1-1 in the shelf ID 601; accordingly, the order group coordination unit 1102 registers S2-1 to the shelf ID 601 of the order line of ID13.

Further, the order group coordination unit 1102 registers P2 to the workstations 701 of all the order lines belonging to the order group B2.

The order group B3 does not include an order line having identification information of a plurality of shelves in the shelf ID 601; accordingly, the order group coordination unit 1102 can assign the order group B3 to any workstation 104.

After registering identification information of a single shelf in the shelf ID 601 and identification information of a workstation 104 in the workstation 701 on all the order lines belonging to any one of the order groups, the order group coordination unit 1102 adds transport IDs in the same policy used by the order group creation unit 202 in Embodiment 1.

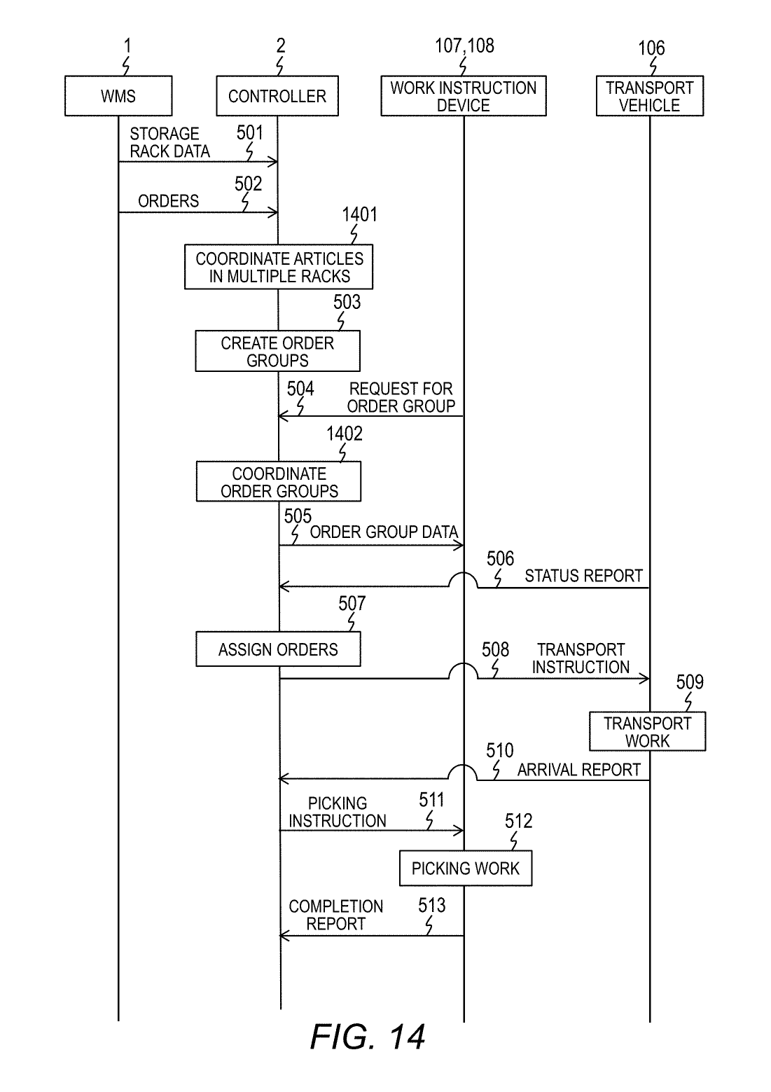

FIG. 14 is a sequence diagram of the processing of the order picking system in Embodiment 6. In the processing shown in FIG. 14, the identical processing to the processing shown in FIG. 5 is assigned the same reference sign and description thereof is omitted herein.

In FIG. 14, in response to receipt of storage rack data 212 at the controller 2, the multiple rack article coordination unit 1101 detects the articles stored in a plurality of storage racks 105 with reference to the received storage rack data 212 and associates each storage rack 105 with a workstation 104 (1401).

At Step 503, the order group creation unit 202 creates order groups. If there is an order group including an order line having identification information of a plurality of shelves in the shelf ID 601, the order group creation unit 202 does not add transport IDs.

In response to receipt of a request for an order group from a work instruction device installed in a workstation 104 at the controller 2, the order group coordination unit 1102 determines identification information of a single shelf for the shelf ID 601 from the identification information of multiple shelves in the shelf ID 601 of each order line having identification information of multiple shelves among the order lines belonging to the order groups created by the order group creation unit 202 and registers the identification information of the determined shelf to the shelf ID 601 of the order line (1402). At Step 1402, the order group coordination unit 1102 further registers the identification information of the workstation associated with the identification information of the determined shelf to the workstation 701 of the order line and adds a transport ID to every order line.

At Step 505, the controller 2 determines an order group assigned to the workstation equipped with the work instruction device that has sent the request for an order group with reference to the workstations 701 of the order data 211 shown in FIG. 13B and sends the determined order group to the work instruction device.

The subsequent processing is the same as the processing shown in FIG. 5; accordingly, the description thereof is omitted herein.

Although the order group coordination unit 1102 determines identification information of a single shelf for an order line for an article stored in a plurality of storage racks based on the relationship with the other order lines belonging to the same order group, the policy of determination is not limited to this. For example, the order group coordination unit 1102 determines in advance a shelf of a storage rack 105 to be prioritized among the shelves of the plurality of storage racks 105 holding the article and in determining a shelf for the order line for the article stored in a plurality of storage racks 105, determines the shelf having the priority. Since this configuration does not need to determine the shelf based on the relationship with the other order lines, lower processing load to the controller 2 is achieved.

After determining identification information of the single shelf having the priority for the identification information of the shelf for the order line having identification information of a plurality of shelves, the order group coordination unit 1102 decreases the value in the quantity 1203 of the record in the storage rack data 212 having the identification information of the determined shelf in the shelf ID 1201 and having the identification information of the article in the order line in the article 1202 by the quantity in the order line. The order group coordination unit 1102 determines in advance a shelf having the next priority among the shelves of the plurality of storage racks 105 storing the article in case where the quantity 1203 of the record in the storage rack data 212 becomes 0. For example, priority numbers can be assigned to the shelves of the plurality of storage racks 105 holding the article.

In the case where the same articles are stored on shelves of a plurality of storage racks 105, the multiple shelf article coordination unit 1101 determines a workstation 104 for each storage rack 105 based on the distance from the storage rack 105 to the workstation 104; however, the multiple shelf article coordination unit 1101 can determine a workstation 104 for each storage rack 105 based on the order of storing the article to the storage racks 105.

Assume that the storage rack 105 that has stored a given article first is associated with a workstation P1 and the storage rack 105 that has stored the article next is associated with a workstation P2. In the case where the articles A are first stored onto the shelf S1-1 and next onto the shelf S2-1, the multiple rack article coordination unit 1101 associates the shelf S1-1 that has stored the article A first with the workstation P1 and associates the shelf S2-1 that has stored the article A next with the workstation P2. That is to say, the workstation to be associated with each shelf is determined based on the anteroposterior relationship of storing the article onto the shelves of the storage racks 105.

This configuration can address the case where the storage racks 105 are relocated as being used, by determining the next location of a storage rack 105 to be the workstation 104 in accordance with the order of storing the article.

In the case where an article is stored on shelves of a plurality of storage racks 105, if another article stored in one of the storage racks has already been associated with a workstation, the multiple rack article coordination unit 1101 associates the article stored in the storage rack 105 with the workstation already associated with the other article, regardless of the distance between the storage rack 105 and the workstation. This policy reduces the possibility that a storage rack 105 is to be simultaneously transported to a plurality of workstations 104, so that the working efficiency improves.

This embodiment has been described based on Embodiment 2 in which shelves are taken into account but is applicable to Embodiment 1 in which the shelves are not taken into account and also, applicable to Embodiments 3 to 5.

The controller 2 in this embodiment identifies articles stored in a plurality of storage racks with reference to the storage rack data 212 and if a created order group includes an order for an article stored in a plurality of storage racks, determines a storage rack for the ordered article from the plurality of storage racks based on the other orders included in the order group or the priority order provided to the plurality of storage racks. This configuration enables determination of a storage rack for the worker to retrieve the article even though an order for the article stored in a plurality of storage racks is placed.

In addition, the configuration of determining a storage rack for an ordered article from a plurality of storage racks based on the other orders belonging to the same order group enables determination of a storage rack that achieves a minimum number of transport trips for the transport vehicle 106. The configuration of determining a storage rack for an ordered article from a plurality of storage racks in accordance with the priority order assigned to the plurality of storage racks can reduce the processing load to the controller 2.

The controller 2 in this embodiment determines the workstations where to transport a plurality of storage racks holding the same article so that the distance from a storage rack to a workstation will be shortest; accordingly, the travel distance of the transport vehicle 106 can be reduced and high working efficiency is achieved.

The controller 2 in this embodiment determines the workstations where to transport a plurality of storage racks holding the same article based on the anteroposterior relationship of storing the article; accordingly, even if the storage racks 105 are relocated in accordance with the order of use, the storage racks 105 can be transported to the optimum workstations.

It should be noted that this invention is not limited to the above-described embodiments but include various modifications. For example, the above-described embodiments have provided details for the sake of better understanding of this invention; they are not limited to those including all the configurations that have been described. A part of the configuration of each embodiment may be replaced with a configuration of another embodiment or a configuration of an embodiment may be incorporated to a configuration of another embodiment. A part of the configuration of each embodiment may be added, deleted, or replaced by that of a different configuration.

The above-described configurations, functions, and processing units, for all or a part of them, may be implemented by hardware: for example, by designing an integrated circuit.

The above-described configurations and functions may be implemented by software, which means that a processor interprets and executes programs providing the functions.

The information of programs, tables, and files to implement the functions may be stored in a storage device such as a memory, a hard disk drive, or an SSD (Solid State Drive), or a storage medium such as an IC card, or an SD card.

The drawings shows control lines and information lines as considered necessary for explanations but do not show all control lines or information lines in the products. It can be considered that most of all components are actually interconnected.

1.-13. (canceled)

14. An order management apparatus configured to manage orders each including an article to be delivered and a delivery destination of the article, the order management apparatus comprising:
a memory is configured to hold identification information of articles, identification information of storage racks holding the articles, and delivery destinations of the articles;
a reception unit configured to receive input of the orders;
an order group creation unit configured to create a plurality of order groups based on identification information of storage racks holding articles included in the received orders and delivery destinations included in the orders;
an order group transmission unit configured to notify a worker in a workstation of orders belonging to one of the plurality of created order groups; and
an order assignment unit configured to send a transport instruction to a transport vehicle to transport a storage rack holding an article in at least one of the orders the worker in the workstation is notified of.

15. The order management apparatus according to claim 14,
wherein the workstation is equipped with at least one compartment for the worker to allocate the article for the delivery destination, and
wherein the order group creation unit is configured to create the plurality of order groups to satisfy conditions that orders having the same delivery destination belong to the same order group and that number of orders belonging to one order group does not exceed number of compartments.

16. The order management apparatus according to claim 15,
wherein the order group transmission unit is configured to notify the worker in the workstation of orders belonging to another one of the created order groups when all articles included in the orders belonging to the order group the worker in the workstation is notified of have been allocated for the delivery destinations, and
wherein the order assignment unit is configured to send another transport instruction to the transport vehicle to transport a storage rack holding an article for which no transport instruction has been sent among the orders belonging to the order group the worker in the workstation is notified of when the transport vehicle has completed a transport trip.

17. The order management apparatus according to claim 14,
wherein each of the storage racks has a plurality of shelves,
wherein the memory is configured to further hold identification information of shelves holding the articles,
wherein the order group creation unit is configured to create the plurality of order groups to satisfy a condition that orders for which identification information of a storage rack is identical and identification information of a shelf is different belong to different order groups.

18. The order management apparatus according to claim 14,
wherein each of the storage racks has a plurality of shelves,
wherein the memory is configured to further hold identification information of shelves holding the articles,
wherein the order group creation unit is configured to create the plurality of order groups to satisfy a condition that orders for which identification information of a storage rack is identical and identification information of a shelf is different belong to the same order group.

19. The order management apparatus according to claim 14,
wherein the workstation is one of a plurality of workstations,
wherein the order group transmission unit is configured to notify a worker in a workstation who has sent a request for an order group of orders belonging to one of the plurality of created order groups,
wherein the order assignment unit is configured to:
send a transport instruction to a transport vehicle to transport a storage rack for at least one order belonging to the order group the worker in the workstation is notified of; and
manage the workstation to which the orders belonging to the order group are sent and the transport vehicle to which the transport instruction is sent.

20. The order management apparatus according to claim 19, wherein the order assignment unit is configured to:
calculate number of transport vehicles to which transport instructions have been sent for each of the plurality of workstations, before sending a new transport instruction to a transport vehicle; and
send the new transport instruction to the transport vehicle to transport a storage rack holding an article in an order belonging to an order group sent to a workstation for which the smallest number of transport vehicles have been sent transport instructions.

21. The order management apparatus according to claim 15,
wherein the workstation is equipped with a plurality of compartments,
wherein the plurality of compartments are grouped by a predetermined number;
wherein the order group creation unit is configured to create the plurality of order groups to satisfy conditions that orders having the same delivery destination belong to the same order group and that number of orders belonging to one order group does not exceed the predetermined number, and
wherein the order group transmission unit is configured to notify the worker in the workstation of the orders belonging to as many order groups as the compartment groups in the workstation out of the plurality of created order groups.

22. The order management apparatus according to claim 14, wherein the order group creation unit is configured to create an order group in response to receipt of a request for an order group from the workstation.

23. The order management apparatus according to claim 1, further comprising:
a multiple rack article coordination unit configured to identify an article stored in a plurality of storage racks based on the identification information of articles and the identification information of storage racks holding the articles; and
an order group coordination unit configured to determine, in a case where one of the created order groups includes an order for the article stored in the plurality of storage racks, a storage rack for the article in the order out of the plurality of storage racks based on the other orders belonging to the order group or in accordance with a priority order specified for the plurality of storage racks.

24. The order management apparatus according to claim 23,
wherein the workstation is one of a plurality of workstations,
wherein the multiple rack article coordination unit is configured to determine, in a case where an article stored in a plurality of storage racks is identified, a workstation at a shortest distance from a storage rack storing the identified article to be the workstation where to transport the storage rack, for each of the plurality of storage racks, and
wherein the order group transmission unit is configured to notify the worker in the workstation where to transport the storage rack determined for the article in the order of an order group including the order for the article stored in the plurality of storage racks.

25. The order management apparatus according to claim 23,
wherein the workstation is one of a plurality of workstations,
wherein the multiple rack article coordination unit is configured to determine, in a case where an article stored in a plurality of storage racks is identified, a workstation where to transport a storage rack based on an anteroposterior relation of storing the article to the plurality of storage racks, for each of the plurality of storage racks, and
wherein the order group transmission unit is configured to notify the worker in the workstation where to transport the storage rack determined for the article in the order of an order group including the order for the article stored in the plurality of storage racks.

26. An order management method for managing orders each including an article to be delivered and a delivery destination of the article, the order management method comprising:
holding identification information on articles, identification information on storage racks holding the articles, and delivery destinations of the articles;
receiving input of the orders;
create a plurality of order groups based on identification information of storage racks holding articles included in the received orders and delivery destinations included in the orders;
notifying a worker in a workstation of orders belonging to one of the plurality of created order groups; and
sending a transport instruction to a transport vehicle to transport a storage rack holding an article in at least one order belonging to the order group the worker in the workstation is notified of.

27. The order management apparatus according to claim 14, wherein the order group creation unit is configured to create the plurality of order groups to satisfy a condition that storage racks are transported to the workstation in a minimum number of trips.

28. The order management method according to claim 14, wherein the creating the plurality of order groups creates the plurality of order groups to satisfy a condition that storage racks are transported to the workstation in a minimum number o
